(19) United States
(12) Patent Application Publication
(10) Pub. No.: US 2007/0082196 A1
(43) Pub. Date: Apr. 12, 2007

(54) Antistatic additive and tapes made therefrom

(76) Inventors: Mahfuza B. Ali, Mendota Heights, MN (US); Eugene G. Joseph, Vadnais Heights, MN (US)

Correspondence Address: 3M INNOVATIVE PROPERTIES COMPANY, PO BOX 33427, ST. PAUL, MN, 55133-3427, US

(21) Appl. No.: 11/246,045

(22) Filed: Oct. 7, 2005

(51) Int. Cl. B32B 7/12

(52) U.S. Cl. 428/352; 428/354; 428/355 AC

(57) ABSTRACT

An adhesive tape with an antistatic release coating is provided. The release includes an antistatic additive made from a reaction product of from about 1 to 30 parts hydrophilic monomer, from about 5 to 40 parts ionic monomer, and from about 20 to 80 parts hydrophobic monomer. A release agent can also be added to the release coating. The adhesive tape does not recoil upon itself when unrolled from the tape core.

### FIELD OF INVENTION

The present invention generally relates to an antistatic additive useful for reducing the electric charge that may be generated when unwinding a roll of adhesive tape. In particular, the present invention relates to a terpolymer antistatic additive produced from a hydrophilic monomer, an ionic monomer, and a hydrophobic monomer that, when used with a tape backing significantly reduces the electric charge generated upon unwinding the tape.

### BACKGROUND

Many materials can accumulate static electricity generated by frictional forces created when two layers are sliding across one another, as in, for example, the peeling of two layers away from one another. The static electricity can attract dirt and dust particles, which is usually undesired. In some applications, such as in the electronics field, dirt and dust particles can be unacceptable. The static electricity is not desirable especially upon unwinding a roll of tape. In such a case, the peeled off portion of the tape may be so attracted to the roll of tape that the former wants to cling to the roll of tape or cling to the user's hand thus making it unusable.

Antistatic materials and coatings have been used in an effort to dissipate the static electricity that may accumulate upon unwinding a roll of adhesive tape. In some applications, the antistatic material is a coating applied to the backing of the tape while in other applications, the antistatic material is compounded or blended into a polymer or a release agent. While there are various types of antistatic materials available, those skilled in the art are continually searching and formulating materials specific to a particular application.

### SUMMARY

The present invention provides an antistatic additive that is well suited for use with a polymeric backing and an acrylate-based adhesive. When used alone, the antistatic additive will reduce static electricity generated upon unwinding the tape. The additive, however, is also effective in reducing static electricity when used with a release agent, as better described below.

In one aspect, the present invention relates to an adhesive tape comprising (1) a backing having opposing first and second surfaces, (2) a release coating disposed on the first surface of the backing, the release coating comprising an antistatic additive comprising (i) from about 1 to 30 parts hydrophilic monomer selected from the group consisting of ethyleneoxide acrylate, n-vinyl pyrollidone, 2-methoxyethyl acrylate, hydroxyethyl (meth)acrylate, (meth)acrylic acid, and combinations thereof; (ii) from about 5 to 40 parts ionic monomer selected from the group consisting of dimethylaminoethyl (meth)acrylate methyl chloride and dimethyl aminoethyl methacrylate alkyl bromide, wherein alkyl is C₄, C₆, C₁₀, C₁₂, C₁₆, C₁₈, or C₂₂; and (iii) from about 20 to 80 parts hydrophobic monomer selected from the group consisting of isobutyl methacrylate, isobornyl (meth)acrylate, isooctyl acrylate, and butyl acrylate, and combinations thereof; and (3) acrylate-based adhesive layer disposed on the second surface of the backing.

In another aspect, the present invention relates to an adhesive tape comprising (1) a backing having opposing first and second surfaces; (2) a release coating disposed on the first surface of the tape film, the release coating comprising an antistatic additive comprising about 20 parts ethyleneoxide acrylate, about 20 parts dimethylaminoethyl (meth)acrylate methyl chloride, and about 60 parts isobutyl methacrylate; (3) and acrylate-based adhesive layer disposed on the second surface of the tape film.

In yet another aspect, the present invention relates to an antistatic additive made from a reaction product of (1) from about 1 to 30 parts hydrophilic monomer selected from the group consisting of ethyleneoxide acrylate, n-vinyl pyrollidone, 2-methoxyethyl acrylate, hydroxyethyl (meth)acrylate, (meth)acrylic acid, and combinations thereof; (2) from about 5 to 40 parts ionic monomer selected from the group consisting of dimethylaminoethyl (meth)acrylate methyl chloride and dimethyl aminoethyl methacrylate alkyl bromide, wherein alkyl is C₄, C₆, C₁₀, C₁₂, C₁₆, C₁₈, or C₂₂; (3) from about 20 to 80 parts hydrophobic monomer selected from the group consisting of isobutyl methacrylate, isobornyl (meth)acrylate, isooctyl acrylate, and butyl acrylate, and combinations thereof (4) from about 0.1 to 1 part initiator; and (5) solvent selected from the group consisting of methanol, ethanol, isopropyl alcohol, ethyl acetate, methyl ethyl ketone, water, and combinations thereof.

One of the advantages of the present invention is that the antistatic additive in the release coating minimizes the chance that an unwound section of tape will recoil upon itself so as to render it useless.

Unless otherwise stated, within this written description, which includes the examples section, the term “about” is presumed to modify all numerical values and all “parts” are give by weight.

### BRIEF DESCRIPTION OF THE DRAWINGS

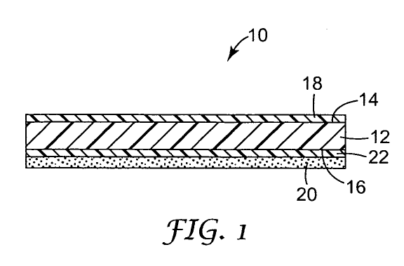

The invention can be further described with reference to the drawings, wherein FIG. 1 is a cross sectional view of one embodiment of adhesive tape 10.

The FIGURE is idealized, not drawn to scale, and is intended for illustrative purposes.

### DETAILED DESCRIPTION

Referring now to FIG. 1, adhesive tape 10 has backing 12 having opposing first surface 14 and second surface 16. Release coating 18 is disposed on the first surface of the backing while adhesive 20 is disposed on the second surface of the backing. Optionally, primer 22 can be applied to the second surface of the backing so as to be sandwiched between the backing and the adhesive.

In one embodiment, the adhesive tape is crystal clear. As used herein, the term “crystal clear” generally means that the tape transmits visible light without substantial light diffraction so that when the tape is applied to paper, a user would not easily discern the presence of the tape on the paper.

The adhesive tape of the present invention includes a backing. Suitable materials that can be used as the backing include, but are not limited to, paper, polymeric film, fabric-reinforced polymeric film, and foam. A suitable polymeric film includes biaxially oriented polypropylene homopolymer or copolymer made from polypropylene and polyethylene blend, as disclosed in U.S. Pat. Nos. 4,045,515; 4,137,362; and 4,451,533. Another suitable polymeric film is a multilayer biaxially oriented film having at least one primary layer and at least one secondary layer, where the primary layer includes a polypropylene copolymer having a first melting point and the secondary layer has a polypropylene homopolymer or copolymer having a second melting point, the second melting point being greater than the first melting point, as disclosed in U.S. Pat. No. 6,638,637. Another suitable backing is simultaneously oriented polypropylene film, where the film is oriented or stretched in both the machine direction and the transverse direction, i.e., transverse to the machine direction. Because of the backing can be of various materials, the backing can be of any thickness, so long as it is of a thickness that is useful for creating a roll of adhesive tape.

The antistatic additive is a terpolymer that includes a hydrophilic monomer component, an ionic monomer component, and a hydrophobic monomer component. As used herein, the term “hydrophilic” means generally that the monomer has a tendency to bind or absorb water. The term “ionic” means generally that the monomer has an electric charge. And, the term “hydrophobic” means generally that the monomer is substantially incapable of being dissolved in water.

Suitable hydrophilic monomers include ethyleneoxide acrylate, n-vinyl pyrollidone, 2-methoxyethyl acrylate, hydroxyethyl (meth)acrylate, (meth)acrylic acid, and combinations thereof. Suitable ionic monomers include dimethylaminoethyl (meth)acrylate methyl chloride and dimethyl aminoethyl methacrylate alkyl bromide, wherein alkyl is C₄, C₆, C₁₀, C₁₂, C₁₆, C₁₈, or C₂₂. And, suitable hydrophobic monomers include isobutyl methacrylate, isobornyl (meth)acrylate, isooctyl acrylate, and butyl acrylate, and combinations thereof. In formulating the terpolymer, a useful range for each monomer would include from about 1 to 30 parts hydrophilic monomer, from about 5 to 40 parts ionic monomer, and from about 20 to 80 parts hydrophobic monomer.

In making the terpolymer, a typical process would include charging each of the three monomers into a reaction vessel along with an initiator and a solvent. A suitable initiator includes 2,2′-azobis(2-methylbutanenitrile). Useful solvents would include various alcohols, including but not limited to methanol, ethanol, isopropyl alcohol, ethyl acetate, methyl ethyl ketone, water, and combinations thereof. The system is mixed for a period of time for the reaction to proceed. The resulting terpolymer can be applied to the first surface of the backing to yield the release coating exhibiting antistatic properties. In another embodiment of the invention, the terpolymer can be used with release agents without deleterious effects on the antistatic properties of the resulting release coating.

Suitable release agent for use of with the present invention would include, but are not limited to, tetrapolymer of octadecyl acrylate, acrylonitrile, acrylic acid, and methyl acryate; octadecyl carbamate; polyvinyl alkyl carbamate; and combinations thereof. A suitable octadecyl carbamate is disclosed in U.S. Pat. No. 2,532,011. In formulating the release coating that includes the antistatic additive and the release agent, a useful range for each component would be from about 0.5 to 15 parts by weight antistatic additive and from about 85 to 99.5 parts by weight release agent. The two components can be mixed together and then applied in any suitable means to the first surface of the backing.

The selection of the adhesive for used in the tape depends on the selection of the backing as well as the selection of the release agents used in the release coating. In one embodiment, the adhesive is a pressure sensitive adhesive. Suitable pressure sensitive adhesive includes, but are not limited to, acrylate-based adhesives. As used herein, the term “acrylate-based adhesive” means the adhesive contains at least 50% by weight of acrylate functionality. One suitable acrylate based adhesive is disclosed in U.S. Pat. No. Re 24,906, which describes a 95.4/4.5 isooctyl acrylate/acrylic acid copolymer pressure sensitive adhesive. The adhesive can also be a hot melt adhesive. The adhesive can be applied to the second surface of the backing using any conventional means.

If desired, a primer may be used to increase the adhesion of the selected adhesive to the backing. The appropriate primer depends on the selection of the adhesive and the backing. In one embodiment, when the backing is polypropylene based and when the adhesive is acrylate based, a suitable primer is a chlorinated polyolefin, such as Eastman CP 343-3 commercially available from Eastman Chemicals, Kingsport, Tenn.

In place of or in addition to using a primer to increase the adhesion between the adhesive and the backing, the backing surface can be modified using methods such as, but not limited to, corona treating, frame treatment or nitrogen treatment.

All US Patents cited herein are incorporated by reference in their entirety.

### EXAMPLE

Antistatic Properties Testing

In the examples below, the residual voltage on the surface of tape after unwind at 12 in/min was measured using a 3M™ Static Sensor 709. A comparable device is 3M™ Static Sensor 718, commercially available from 3M Company. A voltage of 100 volts was applied the sample, where the distance between the two electrodes was about 0.75 inch similar to the width of the sample. The voltage measurements were made after the voltage was applied immediately after the tape sample was unwound from the core (initial measurement), after 10 seconds, and after 300 seconds from unwind.

Synthesis of Antistatic Additive

An antistatic additive was synthesized as follows. Into a reaction vessel was added 20 parts hydrophilic monomer ethyleneoxide acrylate, 25 parts ionic monomer dimethylaminoethyl (meth)acrylate methyl chloride (DMAEA-CH₃Cl), 60 parts hydrophobic monomer isobornyl methacrylate, 0.5 parts VAZO 67, which is 2,2′ azobis(2-methylbutanenitrile), and 200 parts isopropyl alcohol as solvent. It should be noted that the DMAEA-CH₃Cl is commercially available from Ciba Geigy as 80% solids solution in water. The resulting mixture was purged with nitrogen for 2 minutes. The vessel sealed and maintained at 65° C. in a constant temperature rotating device for 18 hours during which a clear viscous polymer solution was formed. The vessel was removed from the bath and cooled to room temperature of 23° C. Percent solids analysis revealed a quantitative conversion to polymer.

### Example 1

An adhesive tape of the present invention was made as follows. The backing was simultaneously oriented polypropylene, made as described in U.S. Pat. No. 6,638,637. An antistatic composition was made as follows. 10 parts by weight of antistatic additive made above was added to a vessel along with 90 parts by weight of a release agent. The release agent contained 75 parts by weight of octadecyl carbamate (made as described in U.S. Pat. No. 2,532,011) and 25 parts by weight polyvinyl alkyl carbamate, such as Escoat P-20, commercially available from Anderson Development Company. The antistatic composition was coated to the first side of the polypropylene backing using a conventional notch bar coater at a wet coating thickness of 0.002 inch (0.05 mm) and dried in a conventional oven having a set point of 150° F. and at a web speed of 50 ft/min. To the second surface of the polypropylene backing, a chlorinated polyolefin primer, CP343-3, from Eastman Chemicals Co., was coated using a conventional notch bar coater at a coating thickness of 0.002 inch (0.05 mm) and dried at substantially the same conditions recited above. Subsequently, an acrylate-based adhesive containing 95.5/4.5 isooctyl acrylate/acrylic acid, as described in U.S. Pat. No. Re 24,906, was applied to the second side of the polypropylene backing on top of the primer. The resulting film was wound in a roll to form the adhesive tape. The inventive adhesive tape was unwound and measured for residual voltage on the surface of the tape according to the above test method, and the results are reported in Table 1.

Control

An adhesive tape without any antistatic agent was made as follows. The same backing was used as in Example 1. An release coating was made using 75 parts by weight octadecyl carbamate and 25 parts by weight polyvinyl alkyl carbamate, coated to the first side of the backing and dried as described in Example 1. The same primer and the same adhesive were applied to the second surface of the backing, as described in Example 1. The resulting film was wound in a roll to form the adhesive tape. This control tape was unwound and measured for antistatic properties according to the above test method, and the results are reported in Table 1.

TABLE 1

| | Initial | After 10 seconds | After 300 seconds |
|---|---|---|---|
| Samples | (volts) | (volts) | (volts) |
| Example 1 | 1633 | 157 | 26 |
| Control | 3383 | 2510 | 1793 |

As the data shows, Example 1 containing the antistatic additive had drastic reduction in static energy in the tape adhesive. Thus, when the adhesive tape of Example 1 was unrolled, it did not have a tendency to cling or recoil on itself, as was seen with the Control sample.

What is claimed is:

1. An adhesive tape comprising:
a backing having opposing first and second surfaces;
a release coating disposed on the first surface of the backing, the release coating comprising an antistatic additive comprising:
from about 1 to 30 parts hydrophilic monomer selected from the group consisting of ethyleneoxide acrylate, n-vinyl pyrollidone, 2-methoxyethyl acrylate, hydroxyethyl (meth)acrylate, (meth)acrylic acid, and combinations thereof;
from about 5 to 40 parts ionic monomer selected from the group consisting of dimethylaminoethyl (meth)acrylate methyl chloride and dimethyl aminoethyl methacrylate alkyl bromide, wherein alkyl is C₄, C₆, C₁₀, C₁₂, C₁₆, C₁₈, or C₂₂; and
from about 20 to 80 parts hydrophobic monomer selected from the group consisting of isobutyl methacrylate, isobornyl (meth)acrylate, isooctyl acrylate, and butyl acrylate, and combinations thereof; and
acrylate-based adhesive layer disposed on the second surface of the backing.

2. The adhesive tape of claim 1, wherein the release coating further comprises a release agent selected from the group consisting of a tetrapolymer of octadecyl acrylate, acrylonitrile, acrylic acid, and methyl acryate, octadecyl carbamate, polyvinyl alkyl carbamate, and combinations thereof.

3. The adhesive tape of claim 2, wherein the release coating comprises from about 0.5 to 15 parts by weight antistatic additive and from about 85 to 99.5 parts by weight release agent.

4. The adhesive tape of claims 1 to 3, further comprising a primer disposed between the backing and the adhesive layer.

5. The adhesive tape of claim 4, wherein the primer is a chlorinated polyolefin.

6. The adhesive tape of claim 1, wherein the backing is selected from the group consisting of paper, polymeric film, fabric-reinforced polymeric film, and foam.

7. The adhesive tape of claim 6, wherein the backing is simultaneously biaxially oriented polypropylene.

8. The adhesive tape comprising:
a backing having opposing first and second surfaces;
a release coating disposed on the first surface of the tape film, the release coating comprising an antistatic additive comprising about 20 parts ethyleneoxide acrylate, about 20 parts dimethylaminoethyl (meth)acrylate methyl chloride, and about 60 parts isobutyl methacrylate; and
acrylate-based adhesive layer disposed on the second surface of the tape film.

9. The adhesive tape of claim 8, wherein the release coating further comprises a release agent consisting of octadecyl carbamate and polyvinyl alkyl carbamate.

10. The adhesive tape of claim 9, wherein the release coating comprises from about 0.5 to 15 parts antistatic additive, from about 50 to 80 parts octadecyl carbamate, and from about 20 to 40 parts polyvinyl alkyl carbamate.

11. The adhesive tape of claims 8 to 10 further comprising, a primer disposed between the backing and the adhesive.

12. The adhesive of claim 11, wherein the primer is chlorinated polyolefin.

13. The adhesive tape of claim 8, wherein the backing is paper, polymeric film, fabric-reinforced polymeric film, and foam.

14. The adhesive tape of claim 13, wherein the backing is simultaneously biaxially oriented polypropylene.

15. An antistatic additive made from a reaction product of:
from about 1 to 30 parts hydrophilic monomer selected from the group consisting of ethyleneoxide acrylate, n-vinyl pyrollidone, 2-methoxyethyl acrylate, hydroxyethyl (meth)acrylate, (meth)acrylic acid, and combinations thereof;
from about 5 to 40 parts ionic monomer selected from the group consisting of dimethylaminoethyl (meth)acrylate methyl chloride and dimethyl aminoethyl methacrylate alkyl bromide, wherein alkyl is C₄, C₆, C₁₀, C₁₂, C₁₆, C₁₈, or C₂₂;
from about 20 to 80 parts hydrophobic monomer selected from the group consisting of isobutyl methacrylate, isobornyl (meth)acrylate, isooctyl acrylate, and butyl acrylate, and combinations thereof;
from about 0.1 to 1 part initiator; and
solvent selected from the group consisting of methanol, ethanol, isopropyl alcohol, ethyl acetate, methyl ethyl ketone, water, and combinations thereof.

16. The antistatic additive of claim 15, wherein the initiator is 2,2′-azobis(2-methylbtanenitrile).

17. An antistatic composition comprising the antitstatic additive of claim 16 and a release agent.

18. The antistatic composition of claim 17 comprising from about 0.5 to 15 parts by weight antistatic agent and from about 90 to 99.5 parts by weight release agent.

19. The antistatic composition of claim 17, wherein the release agent is selected from the group consisting of a tetrapolymer of octadecyl acrylate, acrylonitrile, acrylic acid, and methyl acryate; octadecyl carbamate; polyvinyl alkyl carbamate; and combinations thereof.
